(19) United States
(12) Patent Application Publication
(10) Pub. No.: US 2013/0078414 A1
(43) Pub. Date: Mar. 28, 2013

(54) Radiofrequency Compatible and X-ray Translucent Carbon Fiber And Hybrid Carbon Fiber Structures

(71) Applicants: Daniel D. COPPENS, Avondale, PA (US); Nicholas COLLURA, Philadelphia, PA (US)

(72) Inventors: Daniel D. COPPENS, Avondale, PA (US); Nicholas COLLURA, Philadelphia, PA (US)

(73) Assignee: QFIX SYSTEMS, LLC, Avondale, PA (US)

(21) Appl. No.: 13/630,623

(22) Filed: Sep. 28, 2012

Related U.S. Application Data
(60) Provisional application No. 61/540,488, filed on Sep. 28, 2011.

(51) Int. Cl. B32B 3/22; B32B 5/14; B32B 3/12; B32B 5/18

(52) U.S. Cl. CPC B32B 3/22; B32B 5/18; B32B 5/14; B32B 3/12
USPC 428/77; 252/500; 252/502; 252/512; 252/515; 252/513; 252/511; 428/189; 428/314.4; 428/304.4; 428/116

(57) ABSTRACT

The present invention provides a structure constructed of carbon fiber that is compatible with Magnetic Resonance imaging and other radiofrequency technologies. The structure is comprised of carbon fiber elements as well as insulating elements that are substantially x-ray translucent (radiolucent). These elements are arranged in such a way that the structure can be used in modalities such as Magnetic Resonance imaging where carbon fibers typically cannot be used due to image distortion and localized heating. At the same time, the structures are designed to maintain radiolucency that is significantly homogeneous.

### CROSS REFERENCE TO RELATED APPLICATION

The present application claims priority from U.S. Provisional Application Ser. No. 61/540,488, filed on 28 Sep. 2011.

### FIELD OF THE INVENTION

This invention relates to devices designed for Magnetic Resonance (MR) and other radiofrequency (RF) based environments. Specifically, the present invention relates to devices comprising carbon fiber that do not cause interference when used in these environments.

### BACKGROUND OF THE INVENTION

Modern Radiation Therapy requires patient positioning devices that are rigid in order to accurately and repeatably position the patient. In addition, the devices must be compatible with the high-energy radiation used during treatment. The unique properties of carbon fiber, high stiffness and radiolucency, have made it an ideal material for patient positioning devices. As state-of-the-art diagnostic imaging technologies are developed and tailored for use in cancer diagnosis and treatment support, the radiolucent properties of carbon fiber have continued to make it the material of choice for modalities such as PET/CT, SPECT/CT and other technologies that are x-ray based.

Generally, treatment of a tumor by radiation therapy is preceded by a diagnostic imaging procedure called simulation. During simulation, the patient is positioned in the manner anticipated for treatment. This includes the physical orientation of the patient using the positioning and immobilization devices that will be used in treatment. This way the computer data set of the patient (DICOM) contains an accurate representation of the location of the tumor. That data set is then imported into treatment planning software (TPS) so that the treatment can be modeled and planned. It is critical that the patient be simulated in the same position on the same devices as will be used in treatment to ensure accurate tumor location identification for treatment.

Magnetic Resonance (MR) imaging provides significant advantages over x-ray based diagnostic imaging techniques in visualizing and differentiating soft tissues such as tumors. There has long been a strong desire to extend the simulation technology to the use of MR imaging. However, until recently, the spatial accuracy of MR machines was not accurate enough for precise tumor location. And precise tumor location is necessary for accurately aiming the treatment beam. In the past, in order to use MR data, the MR data was overlaid or “fused” with CT data to achieve the required accuracy. However, recent advances in spatial accuracy of MR data allow the use of MR information directly for radiation therapy simulation.

MR imaging uses large magnets to create a homogeneous magnetic field. Gradient coils alter the magnetic field in a uniform manner in time or space, creating magnetic field gradients. MR imaging also employs radiofrequency (RF) coils for applying an RF field to a subject to be imaged, causing the resonant nuclei within the subject to resonate and create an MR response signal. An image is then constructed based on this response signal.

Interference with the RF field reduces the quality of the created image. Susceptibility is used to describe the degree of magnetization a material exhibits per applied magnetic field. If a material with susceptibility much different than the subject being imaged is within the magnetic field the homogeneity of the magnetic field will be disturbed near the material. This creates a distortion in the MR image near this material.

Electrically conducting materials, such as metals, disturb and distort the radiofrequency electromagnetic fields necessary for resonance imaging. The eddy currents in these materials, usually metallic conductors of electricity create their own magnetic field that interferes with the fields used for MR imaging. Carbon fiber, which is conductive along its length, also causes this interference.

Other tumor localization techniques also use radiofrequency (RF) technology, such as those techniques developed by Calypso (Seattle, Wash.). For Calypso RF localization to work properly, the accessories cannot interfere with the RF signal generated and reflected by the RF antenna and Beacons respectively. Small conductors do not pose a problem. However, large conductors, such as the metal plates on the end of the Varian Exact® couch top or sheets of carbon fiber fabric commonly used for patient tables do create signal interference due to eddy current generation.

The electrically conductive nature of carbon fibers is problematic for use in MR imaging machines and other RF devices. Although carbon fiber is not ferro-magnetic, the electrical conductivity can lead to problems such as image distortion and resistance heating of the carbon fiber. The interaction of the carbon fiber with the MR magnetic field causes electrical current to flow through the carbon fibers. This electrical flow can lead to localized magnetic fields as well as localized heating of the material, causing safety concerns. In order to design products that can work in an MRI environment, substitute materials are often used, such as fiberglass and aramid fibers (Kevlar). Although these materials are not conductive, they lack the stiffness of carbon fiber, reducing their applicability to accurate patient positioning during treatment. In the case of fiberglass, the material is not sufficiently radiolucent to be used in significant quantities for structural purposes in an x-ray environment.

The stiffness of commercially available carbon fiber can vary from a modulus of 30 MSI to 120 MSI and greater. As the stiffness increases, the electrical conductivity increases as well. While it can be desirable to make use of these higher stiffness carbon fibers it increases the challenge of incorporating them in MRI compatible structures. This invention makes their use possible.

### SUMMARY OF THE INVENTION

The present invention described herein can mitigate and/or eliminate the problems of image distortion and localized heating inherent to devices constructed of carbon fiber when used in MR applications. This will allow the beneficial properties of carbon fiber to be incorporated into devices that can be used in simulation through radiation treatment regardless of the modalities employed (including MR imaging).

Electrical eddy currents occur in conductive material when exposed to a magnetic field because the electrons in the material are able to circulate forming a closed electrical loop. As with electrical wire, the current is conducted down the carbon fiber's length. By embedding a unidirectional set of the conductive carbon fibers in an electrically insulating matrix resin, we can start to take advantage of the anisotropic nature of the composite material's conductivity. That is to say that the conductivity in the fiber direction is orders of magnitude greater than the conductivity transverse to the fibers. This starts to hinder the electrical current's ability to travel up one fiber, cross over, and return down another fiber. A typical electrical conductivity for carbon fiber is about 10⁵ (S/m) whereas the electrical conductivity for epoxy is around 10⁻¹² (S/m).

Typical commercially available carbon fiber prepreg materials tend to come in sheets with an areal weight running from about 50 GSM (grams per square meter) up to 1000 GSM. This translates to thicknesses in the range of slightly less than 0.005″ up to 0.025″ or slightly higher. These sheets (also called plies) are layered into a laminate to form structures.

In order to produce RF compatible carbon fiber elements, we need to minimize the ability of the electrons to form eddy currents when placed into the magnetic field. This can be achieved (1) by producing long carbon fiber composite elements that are very narrow in the transverse direction and (2) by producing short carbon fiber elements that are wide in the transverse direction. The elements are generally composed of conductive fibers oriented in one direction (unidirectional) embedded in an electrically insulating matrix resin. Fabrics of electrically conductive are generally not suitable for these elements as the fabric will create loops in which eddy currents can form. However, a fabric containing a conductive fiber in one direction and a non-conducting fiber in the other direction would be suitable.

These radiofrequency compatible elements can be used as building blocks to produce radiofrequency compatible structures from carbon fiber. However, we must adequately separate and insulate the individual elements from each other so that we do not develop electrical looping paths from one element to the next.

Insulating separators can be included in the structure in several ways. They can be placed in the same plane as the element, (1) separating elements lateral, in the same ply layer, (2) separating elements longitudinally, also in the same ply layer, or in between plies to separate elements through the thickness of the structure. These strategies can be mixed in the same structure to optimize both structural and RF performance.

Insulating elements can be composed of an insulator such as a pure polymer, a polymer with a scrim material (such as non-woven polyester) or a non-conductive composite structural element such as aramid (Kevlar) so that it contributes to the structural performance as well.

By combining insulating elements with RF compatible carbon fiber elements, a laminate may be produced that is of high structural performance (stiffness and/or strength).

FIG. 3 through FIG. 6 show ways in which conducting elements and insulators can be combined to develop RF compatible lamina (plies). The lamina can then be stacked into a structural laminate that is RF compatible and of high structural performance (stiffness and/or strength). Each lamina can have it's own orientation with respect to the laminate's coordinate system in order to optimize structural performance for any given application.

These laminates can be used in any manner typically employed in composite structure design. They can be used to develop solid structures or can be incorporated in typical composite constructions such as sandwich panels. In FIG. 6, a sandwich panel is shown consisting of RF compatible laminate faces placed on a foam core. The edges are wrapped with an insulating composite material so that the top and bottom skin are electrically isolated from each other.

Specifically, the present invention provides devices for use in the treatment and simulation of treatment of cancerous tissue that can be used inside a magnetic field used for MR imaging without exhibiting image distortion or local heating. The homogeneity of the structure in an X-ray based environment is also an object of this invention so that x-ray artifacting is minimized.

It is another object of the present invention to provide devices that can be used with RF technology such as that developed by Calypso without causing interference with the system that would impact treatment.

More specifically, the present invention provides . . . BG ADD>>>

### BRIEF DESCRIPTION OF THE DRAWINGS

FIG. 1 illustrates elements composed of conductive fibers in the 0 degree direction.

FIG. 2 illustrates typical geometries of the elements in FIG. 1.

FIG. 3 illustrates insulating the elements.

FIG. 4 illustrates insulating the elements.

FIG. 5 shows a construction with multiple elements.

FIG. 6 demonstrates the use of interlaminar and intralaminar insulators in the same laminate.

FIG. 7 shows a cross sectional construction of a patient table or device.

FIG. 8 illustrates a modular insert of the present invention.

FIG. 9 is an example of a couch top construction using the present invention.

FIG. 10 is an example of a modular couch top.

FIG. 11 is an example of a patient positioning device using the present invention.

### DETAILED DESCRIPTION OF THE INVENTION

The present invention provides a device that is compatible with radiofrequency applications such as magnetic resonance imaging and is also x-ray translucent is shown in the figures. The device is to be constructed of both conductive and non-conductive elements. The conductive elements provide bulk of the stiffness of the structure. The non-conducting elements are arranged in such a manner to maximize structural performance while at the same time limiting eddy currents in the device. The limiting of the eddy currents is what allows the device to be used in radiofrequency applications.

FIG. 1 Depicts elements composed of conductive fibers 4 in the 0 degree direction. Conductivity is greatly reduced in the transverse direction as the fibers are embedded in a non-conductive matrix material 6. The element on the left 2 has an aspect ratio that is long in the fiber direction and narrow in the transverse direction. The element on the right 8 is short in the fiber direction and long in the transverse direction. Various aspect ratios may be used to optimize structural performance and minimize electrical conductivity of the system.

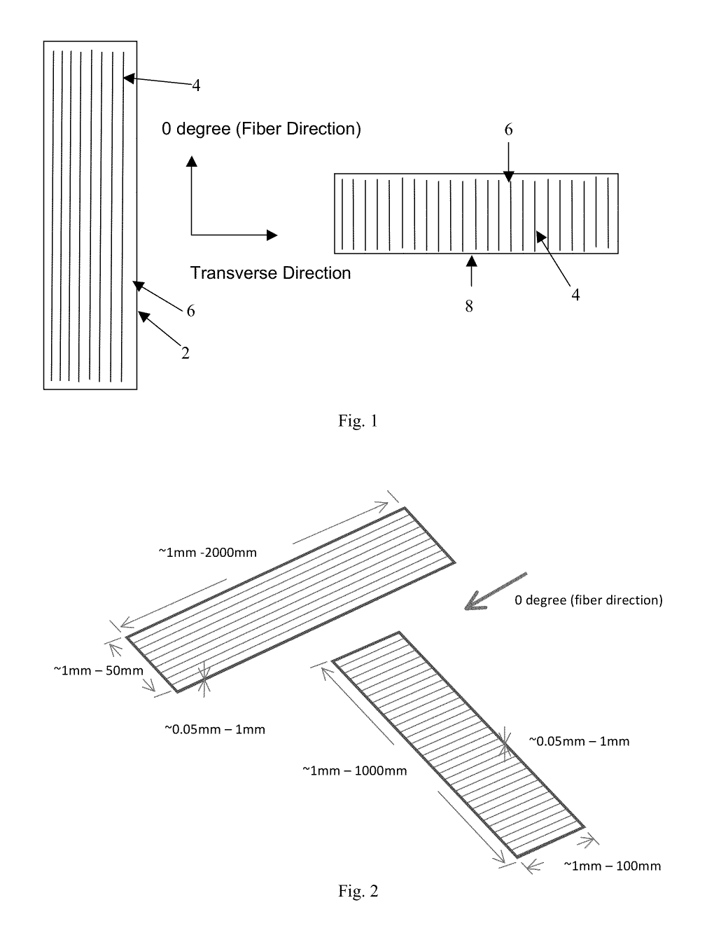

FIG. 2 depicts typical geometries of the elements shown in FIG. 1.

FIG. 3 shows a method of insulating the elements by placing multiple conducting elements 24 in a plane (or sheet), separated laterally by insulators 22. By employing a non-conductive element of similar density to the conductive fiber loaded element, homogeneous x-ray performance can be achieved.

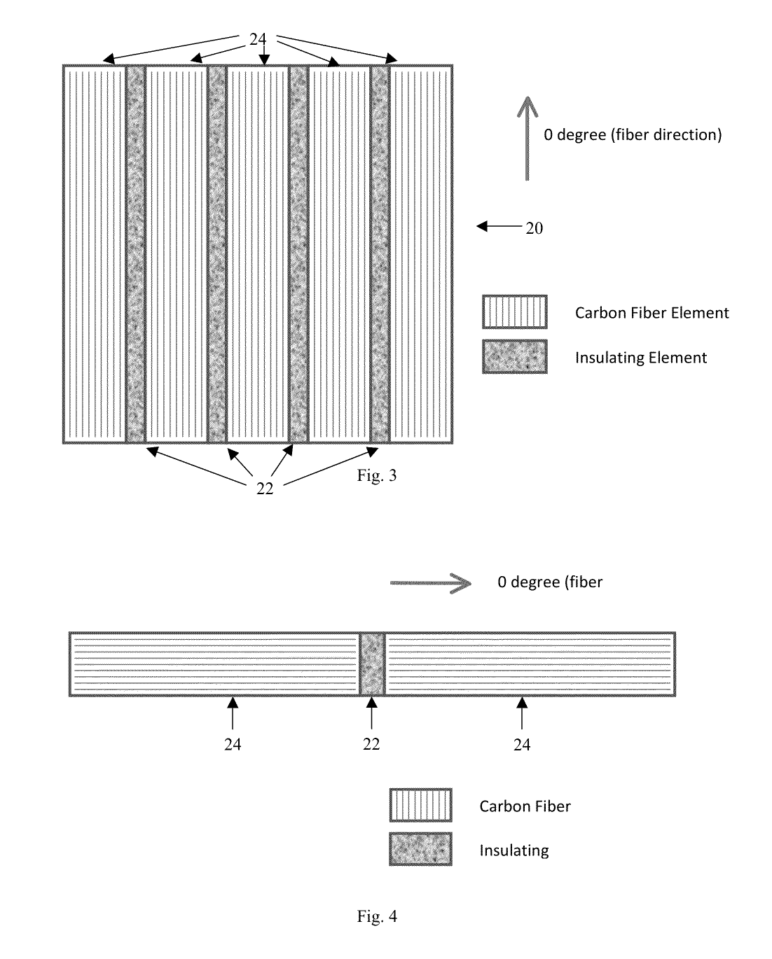

FIG. 4 shows a method of insulating the elements by placing multiple conducting elements 28 in a plane (or sheet), separated longitudinally by insulators 26. By employing a non-conductive element of similar density to the conductive fiber loaded element, homogeneous x-ray performance can be achieved.

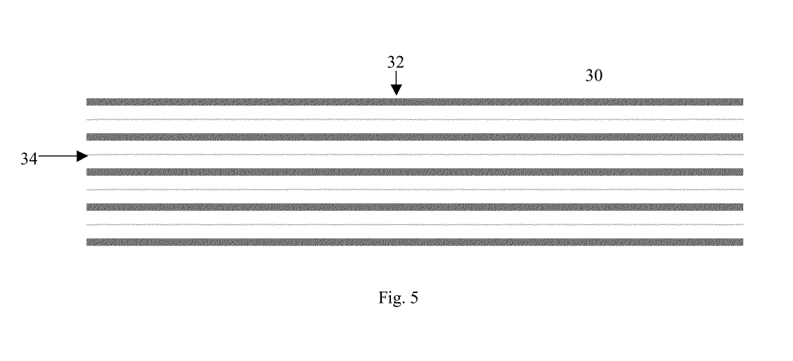

FIG. 5 demonstrates a construction in which sheets of elements (also referred to as plies or lamina) can be layered into a laminate that is compatible with Radio Frequency environments and also x-ray translucent. The 0 degree orientation of each lamina can be placed in any direction with respect to the laminate. In this way, the fiber orientation and structure can be optimized based on the application. An interlaminar insulator 34 is used to separate plies of conducting materials 32 from coming in contact.

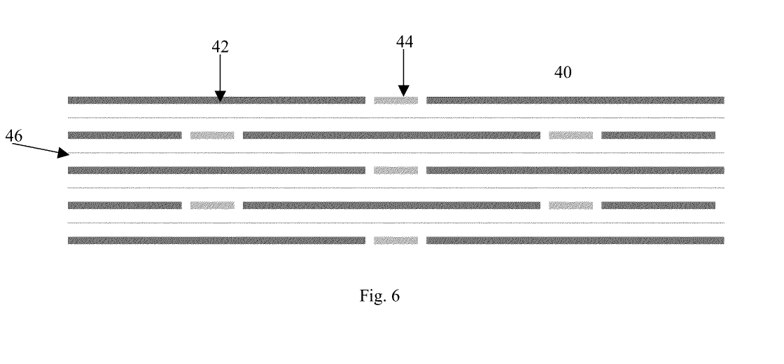

FIG. 6 demonstrates the use of both interlaminar 46 and intralaminar 44 insulators in the same laminate. The joints between conductive and non-conductive elements are staggered to optimize structural performance.

FIG. 7 shows a typical cross sectional construction of a patient table or device that has high structural performance that is RF compatible and x-ray translucent. The top 66 and bottom 68 skins are comprised of lamina as shown in FIG. 6. The top and bottom skins are separated by a non-conductive core 62. In order to maximize the structural integrity, non-conductive materials 64 are wrapped around the edges providing a structural connection between the top and bottom skin. This provides a structural connection without creating an electrical connection.

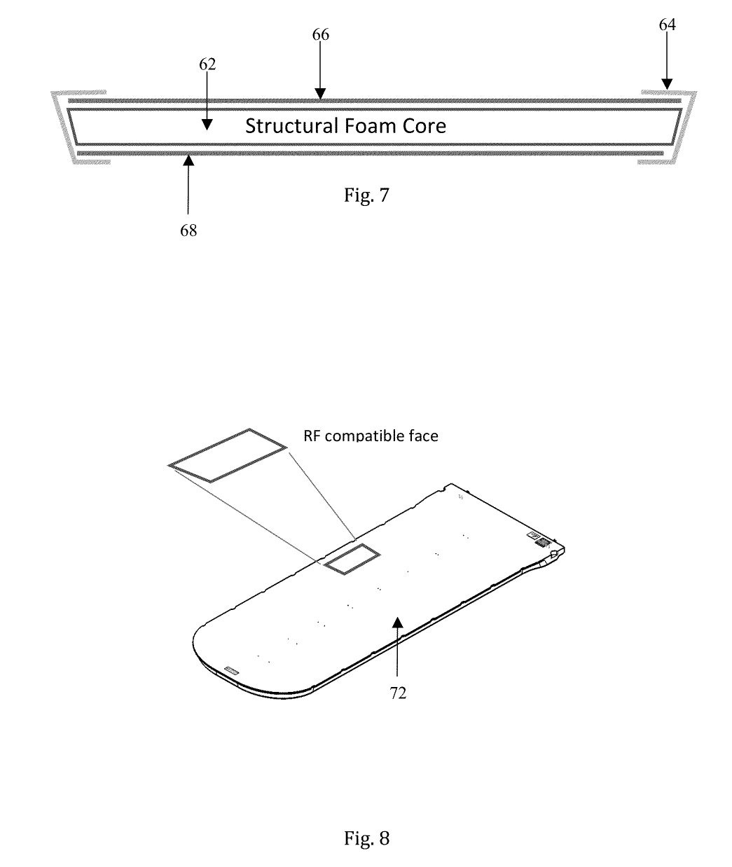

FIG. 8 shows an example of a modular insert 72 for use in radiation therapy constructed in a manner shown in FIG. 7. The modular insert is designed to be used in any imaging or treatment modality.

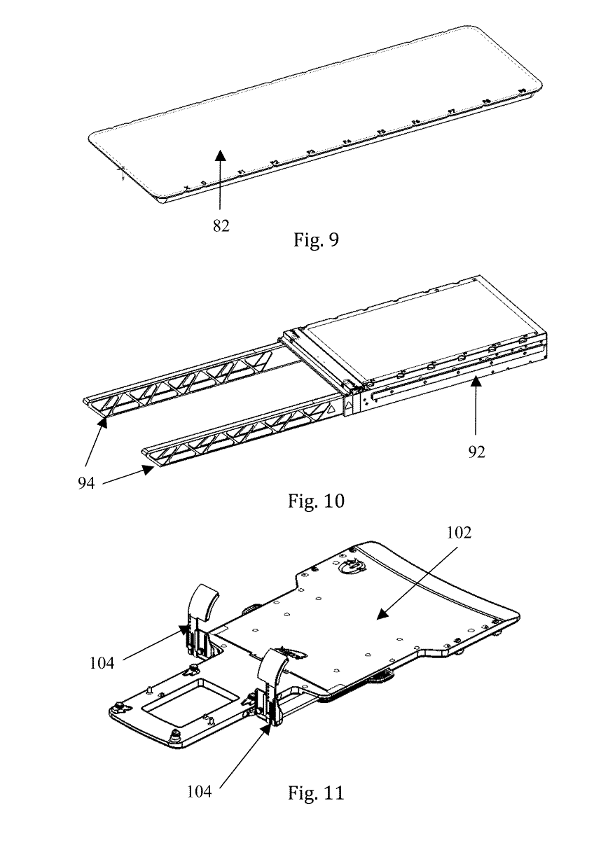

FIG. 9 shows an example of a Monocoque Radiation Therapy Couch Top 82 constructed in the manner shown in FIG. 7. This couch top can be configured for use in any imaging or treatment modality.

FIG. 10 shows a Modular Radiation Therapy Couch Top 94 that can be used in conjunction with the Modular Insert shown in FIG. 8. The structural support beams 94 are constructed in a manner shown in FIG. 3, FIG. 4, FIG. 5 or FIG. 6.

FIG. 11 shows a Patient Positioning Head and Neck Device 102 constructed in the manner shown in FIG. 7. The subcomponents 104 are constructed in any of the manners shown in FIG. 3, FIG. 4, FIG. 5, FIG. 6, and FIG. 7.

The present invention is further defined by the following claims.

We claim:

1. A structure comprising structural, electrically conductive elements and insulating elements configured such that the structure is compatible with radiofrequency devices such as magnetic resonance imaging and is also X-ray translucent.

2. Structures of claim 1 in which the conductive elements are carbon fibers embedded in a non-conductive matrix.

3. Structures of claim 1 in which the element aspect ratio is at least one selected from short in the fiber direction and long in the transverse direction; long in the fiber direction and short in the transverse direction; and approximately an aspect ratio of one.

4. Structures of claim 1 that are used for patient positioning in at least one of MR imaging, RF Localization (Calypso), radiation therapy treatment and diagnostic imaging.

5. Structures of claim 1 where the insulating elements are composed of a structural non-conductive material such as aramid, UHMWPE (Spectra), or fiberglass so that the insulating elements contribute to the structural performance.

6. Structures of claim 1 in which the conductive elements are separated by at least one of interleaving with insulating elements between plies (interlayers), placing insulating elements within the ply (interlayer) in the longitudinal direction, and placing insulating elements within the ply (interlayer) in the lateral direction.

7. Structures of claim 6 that are MRI compatible but not x-ray translucent.

8. Structures of claim 1 in which the conductive elements are at least one selected from the group consisting of aluminum, steel, boron, beryllium, copper, tungsten, titanium, stainless steel, and carbon fiber.

9. Structures of claim 1 in which the joints between conducting and non-conducting materials are staggered to optimize structural performance.

10. Structures of claim 1 in which multiple conductive materials are used in order to optimize at least one of structural performance, RF compatibility, and X-ray translucency.

11. Structures of claim 1 in which multiple insulating materials are used in order to optimize at least one of structural performance, RF compatibility, and x-ray translucency.

12. Sandwich structures of claim 1 employing a core of at least one of closed-cell foam, open-cell foam, honeycomb, and wood.

13. Structures of claim 2 where the non-conductive matrix is at least one of epoxy, polyester, vinylester, and ceramic.

14. Structures of claim 1 wherein the conductive and non-conductive elements are arranged such that the conductive elements come in direct contact with only non-conductive elements.

15. Structures of claim 1 in which at least one of the stiffness and strength of the structure is higher than is achievable by a structure of similar cross-sectional area and weight constructed solely of non-conducting elements.

16. Structures of claim 1 in which the conducting and non-conducting elements are of substantially similar density such that the structure has substantially homogenous x-ray performance.

17. The sandwich structure of claim 13 in which the top and bottom faces of the structure are connected using a connecting structure of non-conducting material.

18. Structures of claim 1 in which the fibers create angles with the long axis of the structure of approximately; 0°, 90°, +45°, −45°, +30°, −30°, +α°, −60 °, 15°, or −15°.
